(19) United States
(12) Patent Application Publication
(10) Pub. No.: US 2026/0336622 A1
(43) Pub. Date: Oct. 29, 2026

(54) VEHICLE DRIVE ASSIST APPARATUS

(71) Applicant: SUBARU CORPORATION, Tokyo (JP)

(72) Inventor: Shinya KUDO, Tokyo (JP)

(21) Appl. No.: 19/709,488

(22) Filed: Jun. 16, 2026

Related U.S. Application Data
(63) Continuation of application No. PCT/JP2024/000287, filed on Jan. 10, 2024.

(51) Int. Cl. B60W 30/18; B60W 30/14

(52) U.S. Cl. CPC B60W 30/18118; B60W 30/143; B60W 2420/403; B60W 2552/15; B60W 2552/53; B60W 2554/802; B60W 2720/10

(57) ABSTRACT

A vehicle drive assist apparatus includes: a driving environment recognizer configured to obtain driving environment information of a vehicle; a target stop position setter configured to, when the driving environment information includes a stopping element for causing the vehicle in motion to automatically stop by adaptive cruise control, set a target stop position based on the stopping element; a target stop position corrector configured to, when the vehicle is traveling on a downhill slope and a gradient change point where the downhill slope transitions to a gentler gradient is present within a set distance from the target stop position, correct the target stop position rearward such that at least rear wheels of the vehicle are positioned on the downhill slope rearward of the gradient change point; and a stop controller configured to cause the vehicle to stop at the target stop position.

### CROSS-REFERENCE TO RELATED APPLICATIONS

This application is continuation of International Application No. PCT/JP2024/000287, filed on Jan. 10, 2024, the entire contents of which are hereby incorporated by reference.

### BACKGROUND

The disclosure relates to a vehicle drive assist apparatus that is equipped with functionality to cause the vehicle to automatically stop.

In recent years, drive assist apparatuses have been put into practical use in vehicles such as automobiles to support the driver's driving operations. These drive assist apparatuses reduce the driving operational burden on the driver and enhance overall safety. Drive assist control by these drive assist apparatuses is generally implemented by combining functions such as adaptive cruise control (ACC) and active lane keep centering (ALKC).

ACC is a type of control that, using a forward recognition device installed in the vehicle, recognizes the distance to a preceding vehicle and controls the vehicle to follow the preceding vehicle accordingly. ACC can bring the vehicle to a stop when the preceding vehicle stops, maintaining a predetermined distance to the preceding vehicle. Furthermore, when the preceding vehicle restarts, ACC can also restart the vehicle, following the preceding vehicle.

For example, Japanese Unexamined Patent Application Publication (JP-A) No. 2010-163058 discloses techniques for causing a vehicle to automatically stop using ACC when a preceding vehicle stops. In vehicle stop control as mentioned above, the controller disclosed in JP-A No. 2010-163058 determines the necessary vehicle-to-vehicle distance based on factors such as the gradient of the road surface on which the vehicle is traveling and the road surface conditions. Accordingly, the technology disclosed in JP-A No. 2010-163058 prevents contact between vehicles even when the vehicle or another vehicle slips on a sloped road or the like, thereby ensuring safety.

By the way, in stop control using ACC, it is desirable not only to ensure safety by optimizing the stop position of the vehicle as described above, but also to achieve further improvements in convenience. For example, in stop control using ACC, it is desirable to reduce the traveling load when the vehicle restarts by optimizing the stop position of the vehicle, and to suppress the output from the power unit at the start of traveling.

The disclosure provides a vehicle drive assist apparatus that can ensure safety using adaptive cruise control (ACC) and suppress the output at the start of traveling.

### SUMMARY

An aspect of the disclosure provides a vehicle drive assist apparatus including a driving environment recognizer, a target stop position setter, a target stop position corrector, and a stop controller. The driving environment recognizer is configured to obtain driving environment information of a vehicle. The target stop position setter is configured to, when the driving environment information includes a stopping element for causing the vehicle in motion to automatically stop by adaptive cruise control, set a target stop position based on the stopping element. The target stop position corrector is configured to, when the vehicle is traveling on a downhill slope and a gradient change point where the downhill slope transitions to a gentler gradient is present within a set distance from the target stop position, correct the target stop position rearward such that at least a rear wheel of the vehicle is positioned on the downhill slope rearward of the gradient change point. The stop controller is configured to cause the vehicle to stop at the target stop position.

An aspect of the disclosure provides a vehicle drive assist apparatus including a driving environment recognition module configured to obtain driving environment information of a vehicle, and a processor. The processor is configured to, when the driving environment information includes a stopping element for causing the vehicle in motion to automatically stop by adaptive cruise control, set a target stop position based on the stopping element. The processor is configured to, when the vehicle is traveling on a downhill slope and a gradient change point where the downhill slope transitions to a gentler gradient is present within a set distance from the target stop position, correct the target stop position rearward such that at least a rear wheel of the vehicle is positioned on the downhill slope rearward of the gradient change point. The processor is configured to cause the vehicle to stop at the target stop position.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 is a schematic configuration diagram of a drive assist apparatus;

FIG. 2 is a flowchart illustrating an adaptive cruise control (ACC) routine;

FIG. 3 is a flowchart illustrating a target stop position calculation subroutine;

FIG. 4 is a flowchart illustrating a target stop position correction subroutine;

FIG. 5 is a diagram illustrating an example of an image when the longitudinal gradient of the road surface is approximately uniform;

FIG. 6 is a diagram illustrating an example of an image when the longitudinal gradient of the road surface changes midway;

FIG. 7 is a map illustrating an example of the relationship between a gradient change amount and a correction amount;

FIG. 8 is a map illustrating an example of the relationship between a following vehicle distance and an upper limit value;

FIG. 9 is a diagram illustrating an example of the relationship between a target stop position before and after correction;

FIG. 10 is a diagram illustrating an example of the relationship between the target stop position before and after correction;

FIG. 11 is a diagram illustrating an example of the relationship between the target stop position before and after correction; and

FIG. 12 is a diagram illustrating an example of the relationship between the target stop position before and after correction.

### DETAILED DESCRIPTION

Hereinafter, an embodiment of an aspect of the disclosure will be described in detail with reference to the drawings. Note that, in the drawings used in the following description, the scales are varied for each component to ensure that it is recognizable in the drawings. Accordingly, the disclosure is not limited to the number of components, the shapes of the components, the size ratios of the components, or the relative positional relationships of the components as illustrated in these drawings.

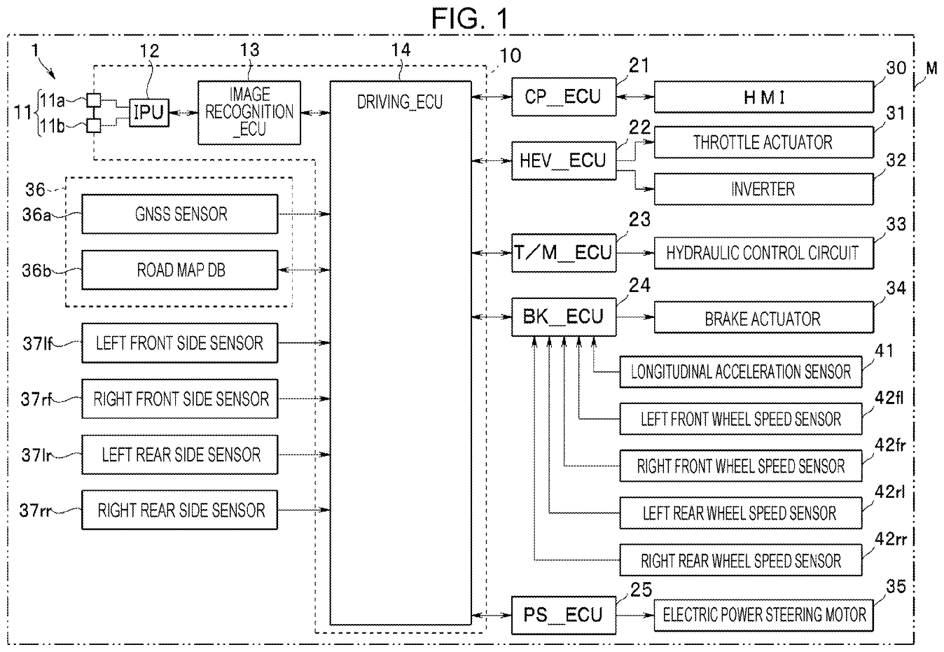

As illustrated in FIG. 1, a drive assist apparatus 1 is installed in a vehicle M, such as an automobile. Note that the vehicle M in the present embodiment is, for example, a hybrid vehicle that uses both an engine and an electric motor as the power sources.

The drive assist apparatus 1 has a camera unit 10. The camera unit 10 is, for example, fixed at the front and upper center of the cabin of the vehicle M.

The camera unit 10 is configured with a stereo camera 11, an image processing unit (IPU) 12, an image recognition unit (image recognition_electronic control unit (ECU)) 13, and a driving control unit (driving_ECU) 14.

The stereo camera 11 includes a main camera 11a and a sub-camera 11b. The main camera 11a and the sub-camera 11b have, for example, color imaging elements such as complementary metal-oxide semiconductor (CMOS). The main camera 11a and the sub-camera 11b are disposed at symmetrical positions on the left and right across the center in the vehicle width direction.

The main camera 11a and the sub-camera 11b perform stereo imaging of the driving environment ahead outside the vehicle M from different viewpoints. The imaging cycles of the main camera 11a and the sub-camera 11b are synchronized with each other.

The IPU 12 applies predetermined image processing to driving environment images captured by the stereo camera 11. In doing so, the IPU 12 detects the edges of various targets such as three-dimensional objects and section lines on the road surface that are represented on the images. Then, the IPU 12 obtains distance information based on a positional shift amount between corresponding edges on the left and right images. Accordingly, the IPU 12 generates image information including the distance information (distance image information).

Based on the distance image information received from the IPU 12, the image recognition_ECU 13 obtains the section lines that define the left and right sides of the lane in which the vehicle M is traveling (the vehicle's traveling lane), the width between the left and right section lines (lane width), and the road curvature [1/m] calculated from the curvature of the left and right section lines. Additionally, the image recognition_ECU 13 obtains the section lines that define the left and right sides of other lanes adjacent to the vehicle's traveling lane, lane width, road curvature, etc.

Furthermore, the image recognition_ECU 13 applies predetermined pattern matching to the distance image information. In doing so, the image recognition_ECU 13 recognizes three-dimensional objects, such as guardrails, curbs, and median strips extending along the road, traffic signals, and surrounding vehicles.

Here, in the recognition of a three-dimensional object by the image recognition_ECU 13, for example, the type of the three-dimensional object, the distance to the three-dimensional object, the speed of the three-dimensional object, and the relative speed between the three-dimensional object and the vehicle M are recognized. Furthermore, when the image recognition_ECU 13 recognizes that the type of the three-dimensional object is a traffic signal, the image recognition_ECU 13 also recognizes the color of the traffic signal.

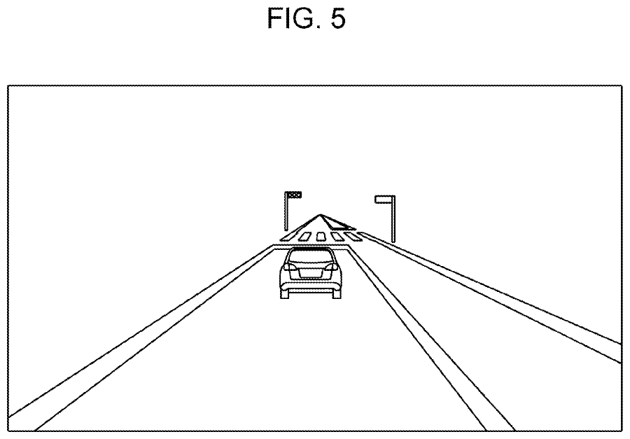

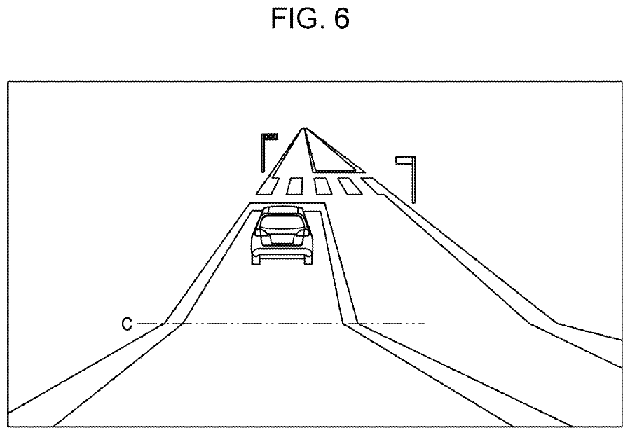

Additionally, the image recognition_ECU 13 recognizes the presence or absence of changes in the longitudinal gradient of the road surface in the vehicle's traveling lane. The presence or absence of changes in the longitudinal gradient can be determined, for example, based on the state of the left and right section lines on the image. Images used for such determination can, for example, be those captured by the main camera 11a (or the sub-camera 11b). For example, as illustrated in FIG. 5, if the rate of decrease in the distance between the left and right section lines on the image is approximately constant, the image recognition_ECU 13 determines that the longitudinal gradient is approximately uniform. In contrast, for example, as illustrated in FIG. 6, if the rate of decrease in the distance between the left and right section lines changes midway on the image, the image recognition_ECU 13 determines that the longitudinal gradient changes midway.

If it is determined that the longitudinal gradient changes midway, the image recognition_ECU 13 recognizes the distance from the vehicle M to a gradient change point C. The distance from the vehicle M to the gradient change point C can, for example, be recognized based on a distance image.

Furthermore, the image recognition_ECU 13 recognizes a gradient change amount of the road surface at the gradient change point C. For example, the image recognition_ECU 13 calculates the gradient change amount by comparing the rate of decrease in the distance between the left and right section lines rearward of the gradient change point C with the rate of decrease in the distance between the left and right section lines forward of the gradient change point C.

These various types of information recognized by the image recognition_ECU 13 are output as driving environment information to the driving_ECU 14.

As mentioned above, in the present embodiment, the image recognition_ECU 13, together with the stereo camera 11 and the IPU 12, corresponds to a specific example as a driving environment recognizer (and a driving environment recognition module) configured to recognize driving environment information outside the vehicle.

The driving_ECU 14 is a control unit configured to supervise and control the drive assist apparatus 1.

Various control units are coupled to the driving_ECU 14 via an in-vehicle communication line such as a controller area network (CAN). For example, a cockpit control unit (CP_ECU) 21, a hybrid control unit (HEV_ECU) 22, a transmission control unit (T/M_ECU) 23, a brake control unit (BK_ECU) 24, and a power steering control unit (PS_ECU) 25 are coupled to the driving_ECU 14.

Furthermore, various sensors are coupled to the driving_ECU 14, including a locator unit 36, a left front side sensor 37lf, a right front side sensor 37rf, a left rear side sensor 37lr, and a right rear side sensor 37rr.

A human machine interface (HMI) 30 located around the driver's seat is coupled to the CP_ECU 21. The HMI 30 includes, for example, an operation switch, a mode selection switch, a steering touch sensor, a turn signal switch, a driver monitoring system (DMS), a touchscreen display, a combination meter, and a speaker. Here, the operation switch is a switch configured to set and execute various types of drive assist control. The mode selection switch is a switch configured to switch the drive assist mode. The steering touch sensor is a sensor configured to detect the driver's steering state. The DMS is a system configured to recognize the driver's face and detect the driver's line of sight.

On receipt of a control signal from the driving_ECU 14, the CP_ECU 21 appropriately informs the driver of various types of information. These various types of information include, for example, various warnings for the preceding vehicle P and the like, the implementation status of drive assist control, and the driving environment of the vehicle M. These various types of information are informed, for example, by means of display and sound using the HMI 30.

Moreover, the CP_ECU 21 outputs various types of input information, entered by the driver using the HMI 30, to the driving_ECU 14. These various types of input information include, for example, an on operation or off operation for various types of drive assist control, the vehicle speed (set vehicle speed) set to the vehicle M, and the operation state of the turn signal switch.

A throttle actuator 31 for an electronically controlled throttle, an inverter 32, and the like are coupled to the output side of the HEV_ECU 22. Moreover, various sensors such as an accelerator sensor (not illustrated) are coupled to the input side of the HEV_ECU 22.

The HEV_ECU 22 applies control to the throttle actuator 31, the inverter 32, and the like based on control signals from the driving_ECU 14 or detection signals from various sensors. Through control of components such as the throttle actuator 31, the HEV_ECU 22 adjusts the amount of air intake of the engine and generates a desired engine output. In addition, through control of components such as the inverter 32, the HEV_ECU 22 generates a desired motor output. Alternatively, through control of components such as the inverter 32, the HEV_ECU 22 generates a braking force through regenerative braking. Additionally, the HEV_ECU 22 outputs signals such as the accelerator opening detected by various sensors to the driving_ECU 14.

A hydraulic control circuit 33 is coupled to the output side of the T/M_ECU 23. Additionally, various sensors such as a shift position sensor (not illustrated) are coupled to the input side of the T/M_ECU 23. The T/M_ECU 23 applies hydraulic control to the hydraulic control circuit 33 based on an engine torque signal and a motor torque signal estimated by the HEV_ECU 22 and detection signals from various sensors. In doing so, the T/M_ECU 23 operates friction engagement elements, pulleys, and the like provided in the automatic transmission, and shifts the engine output at a desired transmission ratio. Furthermore, the T/M_ECU 23 operates friction engagement elements to establish a connection or disconnection between the engine drive shaft and the motor drive shaft. Moreover, the T/M_ECU 23 outputs signals such as a shift position detected by various sensors to the driving_ECU 14.

A brake actuator 34 is coupled to the output side of the BK_ECU 24. The brake actuator 34 adjusts the brake fluid pressure output to a brake wheel cylinder provided in each wheel. Additionally, various sensors are coupled to the input side of the BK_ECU24, including a brake pedal sensor (not illustrated), a longitudinal acceleration sensor 41, and wheel speed sensors 42 (left front wheel speed sensor 42fl, right front wheel speed sensor 42 fr, left rear wheel speed sensor 42rl, and right rear wheel speed sensor 42rr).

The BK_ECU 24 applies driving control to the brake actuator 34 based on a control signal from the driving_ECU 14 or detection signals from various sensors. In doing so, the BK_ECU 24 appropriately generates, in each wheel, a braking force for performing forced braking control (deceleration control) of the vehicle M. The BK_ECU 24 also outputs signals such as the brake operation state, longitudinal acceleration, and vehicle speed detected by various sensors to the driving_ECU 14.

An electric power steering motor 35 is coupled to the output side of the PS_ECU 25. The electric power steering motor 35 imparts steering torque due to the rotational force of the motor to the steering mechanism. Moreover, various sensors such as a steering torque sensor and a steering angle sensor are coupled to the input side of the PS_ECU 25.

The PS_ECU 25 applies driving control to the electric power steering motor 35 based on a control signal from the driving_ECU 14 or detection signals from various sensors. In doing so, the PS_ECU 25 generates steering torque for the steering mechanism. In addition, the PS_ECU 25 outputs signals such as steering torque and a steering angle detected by various sensors to the driving_ECU 14.

The locator unit 36 is configured with a global navigation satellite system (GNSS) sensor 36a and a high-precision road map database (road map DB) 36b.

The GNSS sensor 36a receives positioning signals transmitted from positioning satellites. In doing so, the GNSS sensor 36a measures the position (latitude, longitude, altitude, etc.) of the vehicle M.

The road map DB 36b is a mass storage medium such as a hard disk drive (HDD). The road map DB 36b stores high-precision road map information (dynamic map). The road map information includes, for example, lane width data, lane center position coordinate data, lane progression azimuth angle data, speed limit data, and road surface gradient data as lane data necessary for autonomous driving. The lane data is stored at intervals of several meters for each lane on the road map. The road map DB 36b outputs, as driving environment information, for example, road map information in a set range with respect to the vehicle position measured by the GNSS sensor 36a, to the driving_ECU 14.

As mentioned above, in the present embodiment, the road map DB 36b, together with the GNSS sensor 36a, corresponds to a specific example as a driving environment recognizer (and a driving environment recognition module) configured to recognize driving environment information outside the vehicle.

The left front side sensor 37lf and the right front side sensor 37rf are composed of, for example, millimeter wave radars. The left front side sensor 37lf and the right front side sensor 37rf are disposed in the left and right side parts of the front bumper, for example. The left front side sensor 37lf and the right front side sensor 37rf detect, as driving environment information, three-dimensional objects that are present in the front and side areas diagonally to the left and right of the vehicle M, which are difficult to recognize in images of the stereo cameras 11.

The left rear side sensor 37lr and the right rear side sensor 37rr are composed of, for example, millimeter wave radars. The left rear side sensors 37lr and the right rear side sensors 37rr are disposed in the left and right side parts of the rear bumper, for example. The left rear side sensor 37lr and the right rear side sensor 37rr detect, as driving environment information, three-dimensional objects that are present in the side and rear areas diagonally to the left and right of the vehicle M, which are difficult to recognize with the left front side sensor 37lf and the right front side sensor 37rf.

Here, when each radar is composed of a millimeter wave radar, the millimeter wave radar analyzes a wave reflected from an object with respect to the output radio wave. In doing so, the millimeter wave radar mainly detects three-dimensional objects such as vehicles driving along or behind the vehicle M. In one example, each radar detects, as information on a three-dimensional object, the width of the three-dimensional object, the position of the representative point of the three-dimensional object (relative position with respect to the vehicle M), the speed of the three-dimensional object, and the like.

As mentioned above, in the present embodiment, the left front side sensor 37lf, the right front side sensor 37rf, the left rear side sensor 37lr, and the right rear side sensor 37rr correspond to a specific example as a driving environment recognizer (and a driving environment recognition module) configured to recognize driving environment information outside the vehicle.

Note that the coordinates of each target outside the vehicle M included in the driving environment information recognized by each of the image recognition_ECU 13, the locator unit 36, the left front side sensor 37lf, the right front side sensor 37rf, the left rear side sensor 37lr, and the right rear side sensor 37rr are converted to coordinates in the three-dimensional coordinate system with the center of the vehicle M as the origin, for example. Such coordinate conversions are performed, for example, by the driving_ECU 14.

The following driving modes are set to the driving_ECU 14: a manual driving mode; a first driving control mode and a second driving control mode, which are modes for driving control; and an evacuation mode. Each of these driving modes can be selectively switched by the driving_ECU 14. Such mode switching is performed based on, for example, the operation status of the mode selection switch provided in the HMI 30, for example.

Here, the manual driving mode is a driving mode that involves the driver to hold the steering wheel. That is, the manual driving mode is a driving mode in which the vehicle M is caused to travel according to the driver's driving operations such as a steering operation, an accelerator operation, and a brake operation.

Likewise, the first driving control mode is also a driving mode that involves the driver to hold the steering wheel. That is, the first driving control mode is a so-called semi-autonomous driving mode in which the vehicle M is caused to travel while reflecting the driver's driving operations. The first driving control mode is implemented by, for example, the driving_ECU 14 outputting various control signals to the HEV_ECU 22, the BK_ECU 24, and the PS_ECU 25. In the first driving control mode, adaptive cruise control (ACC), active lane keep centering (ALKC), active lane keep bouncing (ALKB), and lane change control are primarily performed in an appropriate combination. In doing so, the vehicle M is able to travel along the target travel route.

Here, adaptive cruise control (ACC) is basically performed based on driving environment information input from the image recognition_ECU 13 and the like.

In one example, the driving_ECU 14 performs cruise control as part of adaptive cruise control (ACC) when no preceding vehicle P is recognized ahead of the vehicle M by the image recognition_ECU 13 or the like. In this cruise control, the driving_ECU 14 applies acceleration/deceleration control to the vehicle M based on a set vehicle speed input by the driver as a target vehicle speed. In doing so, the driving_ECU 14 maintains the speed of the vehicle M at the set vehicle speed.

In contrast, the driving_ECU 14 performs adaptive cruise control (ACC) when a preceding vehicle P is recognized ahead of the vehicle M by the image recognition_ECU 13 or the like. In the adaptive cruise control, the driving_ECU 14 sets a target vehicle-to-vehicle distance based on the vehicle speed of the preceding vehicle P or the like, and performs acceleration/deceleration control for maintaining the target vehicle-to-vehicle distance.

Here, vehicle speed control in adaptive cruise control (ACC) is performed for, for example, the entire vehicle speed region including the stop state of the vehicle M (the vehicle speed is 0 km/h). That is, when the driving environment includes a stopping element for the vehicle M, the driving_ECU 14 performs automatic stopping control to cause the vehicle M to stop before the stopping element (i.e., on the vehicle M side).

Note that, for example, a stop line when there is a red traffic signal ahead in the vehicle's traveling lane corresponds to a stopping element during execution of cruise control. Additionally, for example, a preceding vehicle P that has stopped due to a red light or similar reason, or a preceding vehicle P that is likely stop due to deceleration corresponds to a stopping element during execution of adaptive cruise control (ACC).

Active lane keep centering (ALKC) and active lane keep bouncing (ALKB) are basically performed based on driving environment information input from one or more of the image recognition_ECU 13 and the locator unit 36. That is, the driving_ECU 14 sets a target route along the left and right lane section lines, in the center of the vehicle's traveling lane, based on, for example, lane section line information included in the driving environment information. Based on the target route, the driving_ECU 14 performs feedforward control and feedback control of steering, thereby maintaining the vehicle M in the center of the lane.

The second driving control mode is a driving mode in which the vehicle M is caused to travel without involving the driver's steering, accelerator operation, or brake operation. That is, the second driving control mode is a so-called autonomous driving mode in which the vehicle M is caused to travel autonomously without involving the driver's driving operations. The second driving control mode is implemented by, for example, the driving_ECU 14 outputting various control signals to the HEV_ECU 22, the BK_ECU 24, and the PS_ECU 25. In the second driving control mode, adaptive cruise control (ACC), active lane keep centering (ALKC), and active lane keep bouncing (ALKB) are primarily performed in an appropriate combination. In doing so, the vehicle M is able to travel along the target route (route map information).

The evacuation mode is a mode for causing the vehicle M to automatically stop on the roadside strip or the like. The evacuation mode is executed, for example, while the vehicle M is traveling in the second driving control mode, when it becomes impossible to continue traveling in the second driving control mode and when the driving operation cannot be handed over to the driver (that is, when the driving mode cannot be changed to the manual driving mode or the first driving control mode).

In the above-described driving modes, the driving_ECU 14 can appropriately apply emergency braking control (autonomous emergency braking (AEB)) or the like to an obstacle such as a vehicle that is highly likely to collide with the vehicle M.

Emergency braking control is basically a control for avoiding a collision with an obstacle that is present ahead in the target route of the vehicle M by performing deceleration control (automatic deceleration control).

In this emergency braking control, the driving_ECU 14 calculates a time to collision (TTC) to collide with the obstacle. The driving_ECU 14 then gradually performs deceleration control to bring the vehicle M to an emergency stop, based on the result of a comparison between the time to collision (TTC) and a preset threshold. Note that such emergency braking control is an interrupt control that is appropriately executed as necessary, regardless of the driving mode. Therefore, for example, even when automatic stop control is being performed as part of adaptive cruise control (ACC), emergency braking control is still executed appropriately when necessary.

Next, automatic stop control during adaptive cruise control (ACC) will be described in detail.

In this automatic stop control, the driving_ECU 14 sets a target stop position with respect to a stopping element.

For example, during execution of cruise control, when a traffic signal ahead in the vehicle's traveling lane turns red, the driving_ECU 14 sets a target stop position at a location positioned a set distance (for example, several tens of centimeters) before the stop line.

Additionally, for example, during execution of adaptive cruise control (ACC), when a preceding vehicle P is at a standstill, the driving_ECU 14 sets a target stop position at a location positioned a set distance (for example, several tens of centimeters) before the preceding vehicle P.

Furthermore, for example, during execution of adaptive cruise control (ACC), when a preceding vehicle P which is decelerating is likely to stop, the driving_ECU 14 calculates a predicted travel distance Lp until the preceding vehicle P stops. Furthermore, the driving_ECU 14 calculates the predicted stop position of the preceding vehicle P by moving the current position of the preceding vehicle P forward by the predicted travel distance Lp. Then, the driving_ECU 14 sets a target stop position at a location positioned a set distance (for example, several tens of centimeters) before the predicted stop position of the preceding vehicle P.

Here, the predicted travel distance Lp can be calculated, for example, using the following equation (1):

Lp=Vp²/(2a·p) (1)

Note that, in equation (1), Vp is the current vehicle speed of the preceding vehicle P. Also, ap is the current deceleration of the preceding vehicle P.

Having set the target stop position, the driving_ECU 14 performs stop control for causing the vehicle M to automatically stop at the target stop position.

In stop control as mentioned above, when the vehicle M is traveling on a downhill slope and a gradient change point C, where the downhill slope transitions to a gentler gradient, is present within a set distance Dth from the target stop position, the driving_ECU 14 corrects the target stop position to a nearer position. Note that, in the present embodiment, cases where the downhill slope transitions to a gentler gradient include not only cases where the downhill slope transitions to a gentler gradient, but also cases where the downhill slope transitions to an uphill slope.

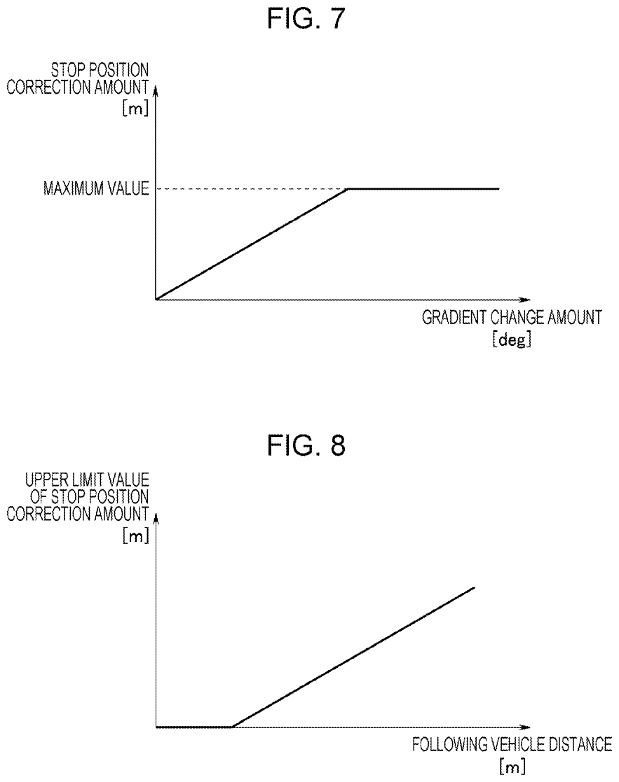

In the correction of the target stop position, the driving_ECU 14 sets a larger stop position correction amount (correction amount) as the gradient change amount becomes larger. The relationship between the gradient change amount and the stop position correction amount is mapped in advance based on, for example, experiments, simulations, etc., and stored in the driving_ECU 14 (see FIG. 7). Note that, in the map illustrated in FIG. 7, a maximum value is set for the stop position correction amount in order to prevent excessive correction for the target stop position. The maximum value of the stop position correction amount is preferably approximately equal to the overall length of the vehicle M (for example, about 4 to 5 meters).

Note that, when a following vehicle F is present behind the vehicle M, the driving_ECU 14 restricts the stop position correction amount as the vehicle-to-vehicle distance (following vehicle distance) between the vehicle M and the following vehicle F decreases. Such restriction of the stop position correction amount can be implemented, for example, by setting an upper limit value for the stop position correction amount according to the following vehicle distance. The relationship between the following vehicle distance and the upper limit value of the stop position correction amount has been mapped in advance based on, for example, experiments, simulations, etc. (see FIG. 8). The map indicating the relationship between the following vehicle distance and the upper limit value is stored in the driving_ECU 14. In this case, in the case where the following vehicle distance is less than a set value (meaning that the distance is markedly short), it is preferable to set the upper limit value for the stop position correction amount to “0” to prohibit correction of the target stop position.

As mentioned above, in the present embodiment, the driving_ECU 14 corresponds to a specific example as a target stop position setter, a target stop position corrector, and a stop controller.

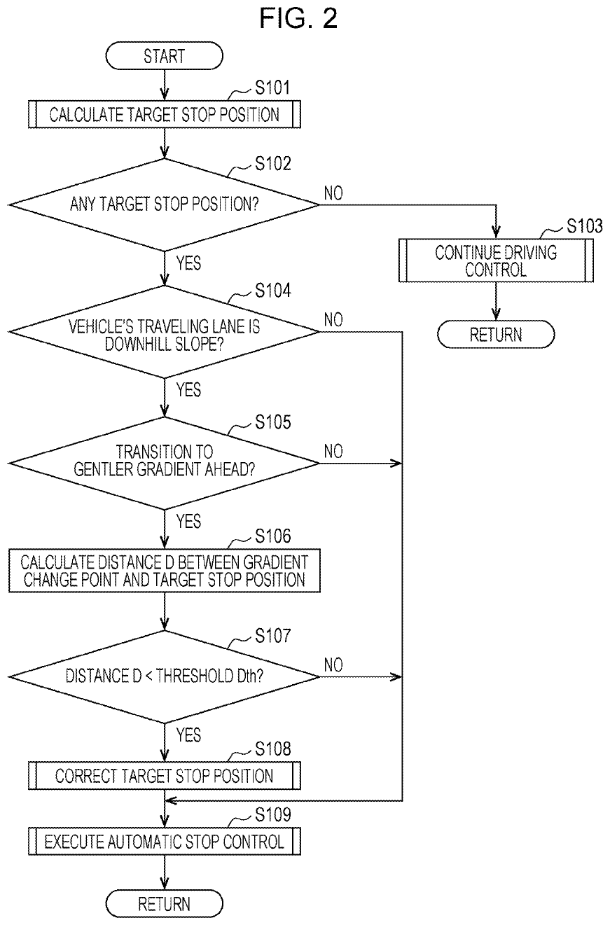

Next, automatic stop control during adaptive cruise control (ACC) will be described according to the flowchart of an adaptive cruise control (ACC) routine illustrated in FIG. 2. This routine is, for example, repeatedly executed at predetermined time intervals by the driving_ECU 14.

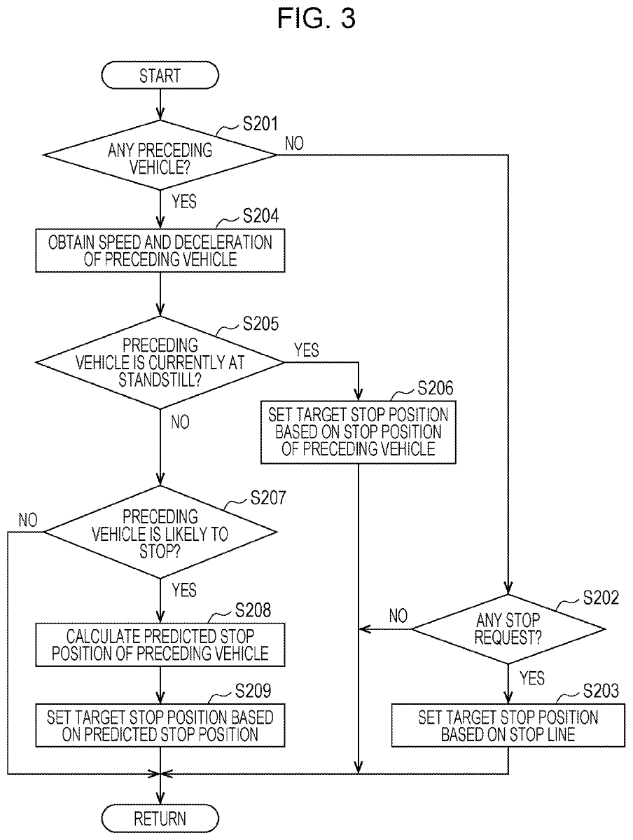

When the routine starts, the driving_ECU 14 calculates a target stop position of the vehicle M in step S101. The calculation of the target stop position is executed, for example, according to the flowchart of a target stop position calculation subroutine illustrated in FIG. 3.

When the subroutine starts, in step S201, the driving_ECU 14 checks whether there is a preceding vehicle P ahead in the vehicle's traveling lane based on driving environment information.

Then, if it is determined in step S201 that a preceding vehicle P is present (step S201: YES), the driving_ECU 14 proceeds to step S204.

In contrast, if it is determined in step S201 that there is no preceding vehicle P (step S201: NO), the driving_ECU 14 proceeds to step S202.

In step S202, the driving_ECU 14 checks whether the driving environment information includes a stop request for the vehicle M. As for a stop request for the vehicle M, for example, the case where a traffic signal is present within a set distance ahead in the vehicle's traveling lane, and the signal is red.

Then, if it is determined in step S202 that the driving environment information includes no stop request for the vehicle M (step S202: NO), the driving_ECU 14 exits the subroutine without setting a target stop position.

In contrast, if it is determined in step S202 that the driving environment information includes a stop request for the vehicle M (step S202: YES), the driving_ECU 14 proceeds to step S203.

In step S203, the driving_ECU 14 sets a target stop position based on a stop line located before the traffic signal, and then exits the subroutine.

Upon proceeding from step S201 to step S204, the driving_ECU 14 obtains the speed Vp and the deceleration ap of the preceding vehicle P based on driving environment information.

Thereafter, in step S205, the driving_ECU 14 checks whether the preceding vehicle P is currently at a standstill based on the speed Vp of the preceding vehicle P.

Then, if it is determined in step S205 that the preceding vehicle P is currently traveling (step S205: NO), the driving_ECU 14 proceeds to step S207.

In contrast, if it is determined in step S205 that the preceding vehicle P is currently at a standstill (step S205: YES), the driving_ECU 14 proceeds to step S206.

In step S206, the driving_ECU 14 sets a target stop position based on the stop position of the preceding vehicle P, and then exits the subroutine.

Additionally, upon proceeding from step S205 to step S207, the driving_ECU 14 checks whether the preceding vehicle P is likely to stop, based on the speed Vp and the deceleration ap of the preceding vehicle P. Here, for example, if the speed Vp of the preceding vehicle P is a low speed that is less than a set vehicle speed and the deceleration ap is greater than or equal to a set deceleration, the driving_ECU 14 determines that the preceding vehicle P is likely to stop.

Then, if it is determined in step S207 that the preceding vehicle P is not likely to stop (step S207: NO), the driving_ECU 14 exits the subroutine as is without setting a target stop position.

In contrast, if it is determined in step S207 that the preceding vehicle P is likely to stop (step S207: YES), the driving_ECU 14 proceeds to step S208.

In step S208, the driving_ECU 14 calculates a predicted stop position of the preceding vehicle P based on the speed Vp and the deceleration ap of the preceding vehicle P. That is, the driving_ECU 14 calculates the predicted travel distance Lp using equation (1) mentioned above based on the speed Vp and the deceleration ap. Then, the driving_ECU 14 calculates a predicted stop position based on the predicted travel distance Lp.

Next, in step S209, the driving_ECU 14 sets a target stop position based on the predicted stop position of the preceding vehicle P, and then exits the subroutine.

In the main routine illustrated in FIG. 2, upon proceeding from step S101 to step S102, the driving_ECU 14 checks whether the target stop position of the vehicle M has been set.

Then, if it is determined in step S102 that the target stop position has been set (step S102: YES), the driving_ECU 14 proceeds to step S104.

In contrast, if it is determined in step S102 that no target stop position has been set (step S102: NO), the driving_ECU 14 proceeds to step S103.

In step S103, the driving_ECU 14 continues the driving control for the vehicle M, and then exits the routine. That is, if no preceding vehicle P has been recognized ahead of the vehicle M, the driving_ECU 14 executes cruise control, and then exits the routine. In contrast, if a preceding vehicle P has been recognized ahead of the vehicle M, the driving_ECU 14 executes adaptive cruise control (ACC), and then exits the routine.

Additionally, upon proceeding from step S102 to step S104, the driving_ECU 14 checks whether the vehicle's traveling lane is a downhill slope. In this determination, the driving_ECU 14 compares, for example, the longitudinal acceleration of the vehicle M, calculated based on the sensor values of the wheel speed sensors 42fl, 42 fr, 42 rl, and 42rr, and the longitudinal acceleration detected by the longitudinal acceleration sensor 41. Then, based on the comparison results of these longitudinal accelerations, the driving_ECU 14 calculates the longitudinal gradient of the vehicle's traveling lane. Alternatively, the driving_ECU 14 can obtain the longitudinal gradient of the vehicle's traveling lane by reading the road surface gradient data from the road map DB 36b.

Then, if it is determined in step S104 that the vehicle's traveling lane is not a downhill slope (step S104: NO), the driving_ECU 14 proceeds to step S109.

In contrast, if it is determined in step S104 that the vehicle's traveling lane is a downhill slope (step S104: YES), the driving_ECU 14 proceeds to step S105.

In step S105, the driving_ECU 14 checks whether the downhill slope transitions to a gentler gradient ahead in the vehicle's traveling lane. In this determination, the driving_ECU 14 can refer to, for example, the driving environment information recognized by the image recognition_ECU 13. Alternatively, if the road map information stored in the road map DB 36b includes road surface gradient data, the driving_ECU 14 can refer to the road map information.

Then, if it is determined in step S105 that the downhill slope does not transition to a gentler gradient ahead (step S105: NO), the driving_ECU 14 proceeds to step S109.

In contrast, if it is determined in step S105 that the downhill slope transitions to a gentler gradient ahead (step S105: YES), the driving_ECU 14 proceeds to step S106.

In step S106, the driving_ECU 14 calculates a distance D between the gradient change point C, where the downhill slope transitions to a gentler gradient, and the target stop position.

Thereafter, in step S107, the driving_ECU 14 checks whether the distance D is less than a preset threshold Dth. Here, the threshold Dth is set to a distance which is approximately equal to the overall length of the vehicle M.

Then, if it is determined in step S107 that the distance D is greater than or equal to the threshold Dth (step S107: NO), the driving_ECU 14 proceeds to step S109.

In contrast, if it is determined in step S107 that the distance D is less than the threshold Dth (step S107: YES), the driving_ECU 14 proceeds to step S108.

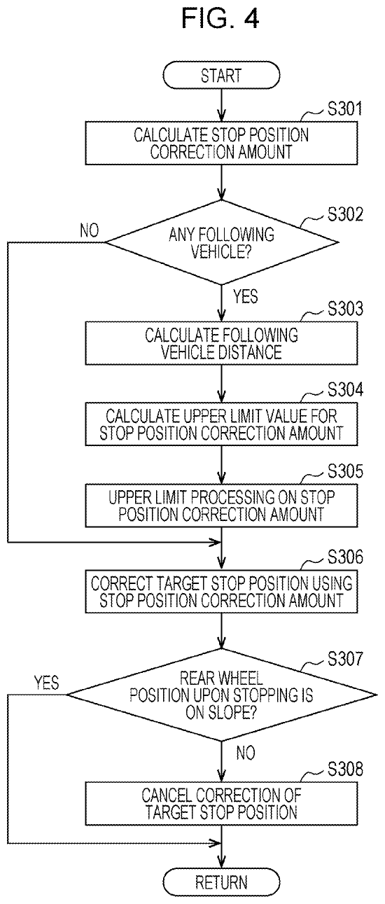

In step S108, the driving_ECU 14 corrects the target stop position. The correction of the target stop position is executed, for example, according to the flowchart of a target stop position correction subroutine illustrated in FIG. 4.

When the subroutine starts, in step S301, the driving_ECU 14 refers to a map such as one illustrated in FIG. 7 based on the gradient change amount, and calculates a stop position correction amount. In this calculation, the driving_ECU 14 can refer to the gradient change amount in the driving environment information recognized by the image recognition_ECU 13. Alternatively, if the road map information stored in the road map DB 36b includes road surface gradient data, the driving_ECU 14 can refer to the road map information.

Next, in step S302, the driving_ECU 14 checks whether there is a following vehicle in the vehicle's traveling lane.

Then, if it is determined in step S302 that there is no following vehicle (step S302: NO), the driving_ECU 14 proceeds to step S306.

In contrast, if it is determined in step S302 that there is a following vehicle (step S302: YES), the driving_ECU 14 proceeds to step S303.

In step S303, the driving_ECU 14 calculates the vehicle-to-vehicle distance (following vehicle distance) from the vehicle M to the following vehicle.

Next, in step S304, the driving_ECU 14 refers to a map such as one illustrated in FIG. 8 based on the following vehicle distance, and calculates an upper limit value for the stop position correction amount.

Next, in step S305, the driving_ECU 14 applies upper limit processing to the stop position correction amount using the upper limit value.

Upon proceeding from step S302 or step S305 to step S306, the driving_ECU 14 corrects the target stop position to a nearer position using the stop position correction amount.

Next, in step S307, the driving_ECU 14 checks whether the rear wheel position when the vehicle M stops is on the downhill slope before the gradient change point C. In this case, the driving_ECU 14 calculates, for example, the position obtained by moving the target stop position toward the near side by a distance corresponding to the length from the front end of the vehicle M to the rear wheels, as the rear wheel position when the vehicle M stops.

Then, if it is determined in step S307 that the rear wheel position when the vehicle M stops is on the downhill slope before the gradient change point C (step S307: YES), the driving_ECU 14 exits the subroutine as is.

In contrast, if it is determined in step S307 that the rear wheel position when the vehicle M stops is not on the downhill slope before the gradient change point C (step S307: NO), the driving_ECU 14 proceeds to step S308.

In step S308, the driving_ECU 14 cancels the correction of the target stop position using the stop position correction amount, and then exits the subroutine.

In the main routine of FIG. 2, upon proceeding from step S104, step S105, step S107, or step S108 to step S109, the driving_ECU 14 executes the automatic stop control of the vehicle M relative to the target stop position, and then exits the routine.

According to the embodiment as above, when the driving environment information includes a stopping element for causing the vehicle M in motion to automatically stop by adaptive cruise control (ACC), the driving_ECU 14 sets a target stop position based on the stopping element. If the vehicle M is traveling on a downhill slope and the gradient change point C, where the downhill slope transitions to a gentler gradient, is present within a set distance from the target stop position, the traveling_ECU 14 corrects the target stop position rearward (i.e., toward the vehicle M), and performs stop control to cause the vehicle M to stop at the target stop position.

In doing so, it is possible to ensure safety using adaptive cruise control (ACC) and suppress the output at the start of traveling.

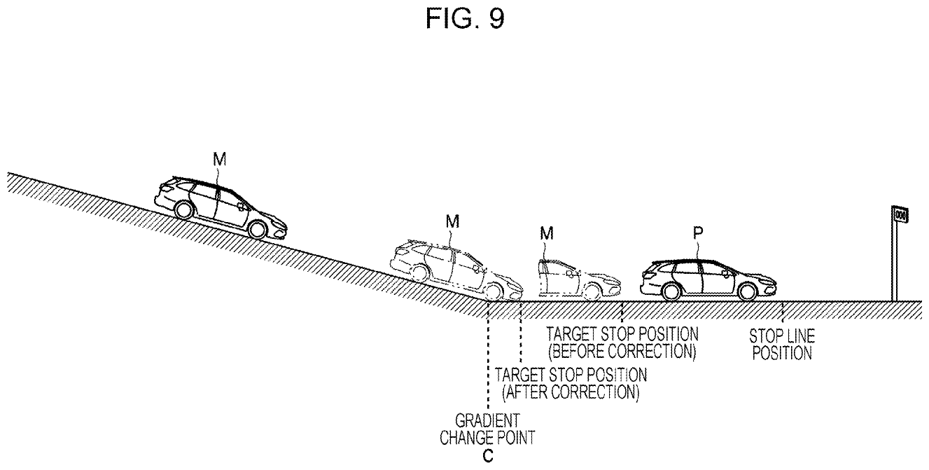

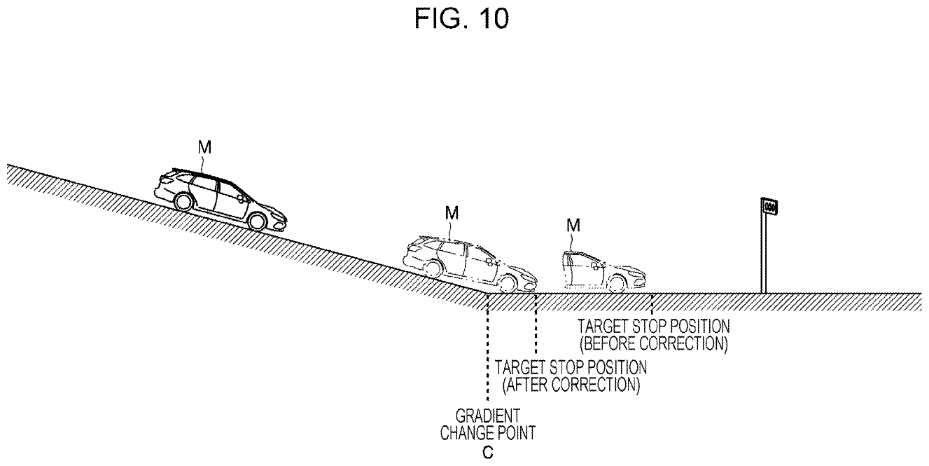

That is, when the vehicle M is traveling on a downhill slope and the gradient change point C, where the downhill slope transitions to a gentler gradient, is present within a set distance from the target stop position, the driving_ECU 14 corrects the target stop position rearward. Through such correction of the stop position, the driving_ECU 14 causes at least a part of the vehicle M to actively stop on the downhill slope before the gradient change point C (see, for example, FIGS. 9 and 10). In doing so, when the vehicle M restarts, it is possible to cause the vehicle M to start traveling by effectively utilizing the potential energy from the downhill slope. Therefore, it is possible to reduce the traveling load when the vehicle starts, and to suitably suppress the output from the power unit at the start of traveling. Here, if the target stop position is corrected as above, the distance between the vehicle M upon starting and the preceding vehicle P is ensured to be longer than usual. Therefore, by utilizing the downhill slope to start the vehicle M, even if the acceleration of the vehicle M exceeds that of the preceding vehicle P, the risk of the vehicle M's collision with the preceding vehicle P can be effectively suppressed.

In this case, the driving_ECU 14 sets a larger correction amount (stop position correction amount) for the target stop position as the gradient change amount before and after the gradient change point C becomes larger. As a result, while effectively utilizing the downhill slope, when a preceding vehicle P is present, a sufficient distance with the preceding vehicle P can also be adequately maintained.

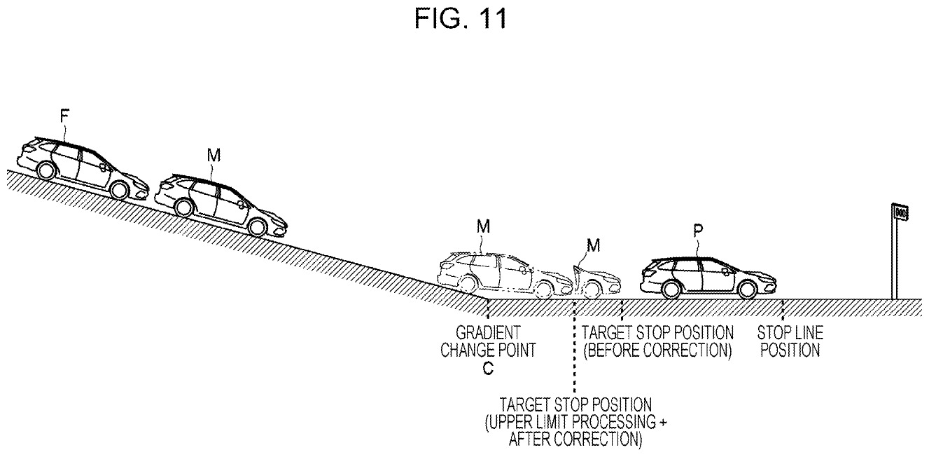

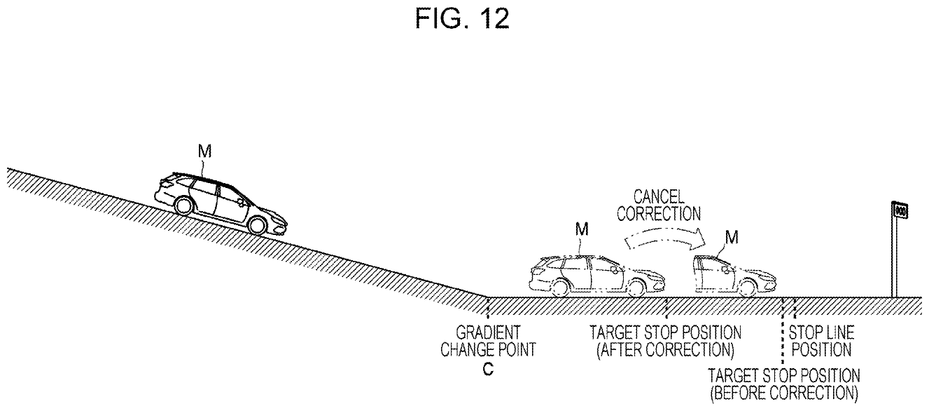

Additionally, if there is a following vehicle F behind the vehicle M, the driving_ECU 14 restricts the correction amount for the target stop position as the vehicle-to-vehicle distance between the vehicle M and the following vehicle F becomes shorter (see, for example, FIG. 11). This makes it possible to suppress the deviation between the stop position of the vehicle M that is expected by the driver of the following vehicle F and the target stop position of the vehicle M. Accordingly, a collision of the following vehicle F with the vehicle M can be suppressed.

Furthermore, when it is expected that, upon stopping the host vehicle M at the corrected target stop position, the rear wheels of the vehicle M will not be positioned on the downhill slope rearward of the gradient change point C, the driving_ECU 14 cancels the correction for the target stop position. In doing so, when it is difficult to effectively utilize the potential energy from the downhill slope, unnecessary corrections to the target stop position can be suppressed.

Here, in the above-described embodiment, the image recognition_ECU 13, the driving_ECU 14, the CP_ECU 21, the HEV_ECU 22, the T/M_ECU 23, the BK_ECU 24, the PS_ECU 25, and the like are formed of a conventional microcomputer including a central processing unit (CPU), random-access memory (RAM), read-only memory (ROM), and a non-volatile storage unit, and one or more peripheral devices thereof. Programs executed by the CPU, fixed data such as data tables, and so forth are stored in advance in the ROM. Note that all or some of the functions of the processor may be configured with a logic circuit or an analog circuit. Additionally, processing of various programs may be implemented by an electronic circuit such as a field-programmable gate array (FPGA).

Note that the disclosure is not limited to the embodiment described above, and various modifications and changes are possible. These modifications and changes are also within the technical scope of the disclosure.

The image recognition_ECU 13, driving_ECU 14, CP_ECU 21, HEV_ECU 22, T/M_ECU 23, BK_ECU 24, and PS_ECU 25 illustrated in FIG. 1 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the image recognition_ECU 13, driving_ECU 14, CP_ECU 21, HEV_ECU 22, T/M_ECU 23, BK_ECU 24, and PS_ECU 25. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 1.

1. A vehicle drive assist apparatus comprising:
a driving environment recognizer configured to obtain driving environment information of a vehicle;
a target stop position setter configured to, when the driving environment information includes a stopping element for causing the vehicle in motion to automatically stop by adaptive cruise control, set a target stop position based on the stopping element;
a target stop position corrector configured to, when the vehicle is traveling on a downhill slope and a gradient change point where the downhill slope transitions to a gentler gradient is present within a set distance from the target stop position, correct the target stop position rearward such that at least a rear wheel of the vehicle is positioned on the downhill slope rearward of the gradient change point; and
a stop controller configured to cause the vehicle to stop at the target stop position.

2. The vehicle drive assist apparatus according to claim 1, wherein the target stop position corrector is configured to set a larger correction amount for the target stop position as a gradient change amount before and after the gradient change point becomes larger.

3. The vehicle drive assist apparatus according to claim 2, wherein the target stop position corrector is configured to, in a case where there is a following vehicle behind the vehicle, restrict the correction amount as a vehicle-to-vehicle distance between the vehicle and the following vehicle becomes shorter.

4. The vehicle drive assist apparatus according to claim 3, wherein the target stop position corrector is configured to, in a case where the vehicle-to-vehicle distance to the following vehicle is less than a set value, prohibit correction of the target stop position.

5. The vehicle drive assist apparatus according to claim 1, wherein the target stop position corrector is configured to cancel the correction in a case where it is expected that, upon stopping the vehicle at the corrected target stop position, the rear wheel of the vehicle will not be positioned on the downhill slope rearward of the gradient change point.

6. The vehicle drive assist apparatus according to Claim 1, wherein the driving environment recognizer is configured to, when a rate of decrease in a distance between left and right section lines that define a lane in which the vehicle is traveling changes midway on an image of the driving environment that has been captured by a camera, determine that the gradient change point is present in the lane in which the vehicle is traveling.

7. A vehicle drive assist apparatus comprising:
a driving environment recognition module comprising a camera or a sensor and configured to obtain driving environment information of a vehicle; and
a processor,
wherein the processor is configured to
when the driving environment information includes a stopping element for causing the vehicle in motion to automatically stop by adaptive cruise control, set a target stop position based on the stopping element,
when the vehicle is traveling on a downhill slope and a gradient change point where the downhill slope transitions to a gentler gradient is present within a set distance from the target stop position, correct the target stop position rearward such that at least a rear wheel of the vehicle is positioned on the downhill slope rearward of the gradient change point, and
cause the vehicle to stop at the target stop position.
